(19) United States
(12) Patent Application Publication
(10) Pub. No.: US 2006/0125221 A1
(43) Pub. Date: Jun. 15, 2006

(54) Gas bag module

(75) Inventors: Michael Schneider, Sulzbach (DE); Ralph Frisch, Moembris (DE); Andreas Kienzner, Wiesen (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/296,900

(22) Filed: Dec. 8, 2005

(30) Foreign Application Priority Data
Dec. 14, 2004 (DE) 20 2004 019 325.6

(51) Int. Cl. B60R 21/26

(52) U.S. Cl. 280/742; 280/740

(57) ABSTRACT

A gas bag module for a vehicle occupant restraint device includes a gas generator for inflating a gas bag, at least one discharge opening formed in a rigid component of the gas bag module, through which discharge opening gas generated by the gas generator and directed into the gas bag can be discharged, and at least one valve flap which in a closed position closes the discharge opening and in an open position exposes the discharge opening. The valve flap is in an initial closed position in the non-activated state of the module. At least one detent device is provided fixing the valve flap, which moves from the open position into a final closed position, in the closed position.

### TECHNICAL FIELD

The invention relates to a gas bag module for a vehicle occupant restraint device, comprising a gas generator for inflating a gas bag, at least one discharge opening formed in a rigid component of the gas bag module, through which discharge opening the gas generated by the gas generator and directed into the gas bag can be discharged, and at least one valve flap which in a closed position closes the discharge opening and in an open position exposes the discharge opening.

### BACKGROUND OF THE INVENTION

Usually in a gas bag module, the gas bag is to be inflated as quickly as possible with the gas generated by the gas generator. In particular cases, it is desirable, though, not to inflate the gas bag with the entire gas volume available, or, more generally, to discharge gas, for which reason discharge openings are provided in the gas bag module, by the exposure of which the pressure in the gas bag can be limited.

From US 2004/0051285 A1 a gas bag module is known of the type initially mentioned, in which the valve flaps can close or expose two discharge openings formed in a gas generator carrier, and are connected by means of tension bands with a part of the gas bag fabric facing a vehicle occupant. In a case of activation, the valve flaps are initially in the outwardly directed open position. The gas bag is therefore not inflated with the entire available gas volume. If the unfolding gas bag now comes in contact with the vehicle occupant before the gas bag has unfolded so far that the tension bands are taut, then the discharge openings remain open. Thereby, the pressure of the unfolding gas bag and hence the force exerted onto the vehicle occupant is reduced. If the vehicle occupant is in a position which is further away from the gas bag module, then the gas bag likewise unfolds initially slowly, as described above, with the discharge openings open. However, as soon as the gas bag has unfolded so far that the tension bands are taut, the latter draw the valve flaps inwards, whereby the discharge openings are closed against the internal pressure of the gas bag. Therefore no, or only a little gas is discharged through the discharge openings, and the entire gas volume is used for inflating the gas bag.

A further consideration is to construct the gas bag module just described such that the valve flaps are initially closed in the non-activated state of the gas bag, and only open in the case of activation owing to the increasing pressure in the interior of the gas bag.

The solution described hitherto contains a disadvantage. Due to the dynamic processes during the unfolding of the gas bag, it is not always ensured that the tension band remains taut and keeps the discharge opening closed against the internal pressure of the gas bag. Thus it is possible, for example, that a residual elasticity of the tension band in its tension direction leads to an oscillation and hence impairs the closing force.

An object of the present invention consequently consists in further developing the gas bag module known from US 2004/0051285 A1 in a simple and hence favorably priced manner such that the valve flap, opened once and closed again by the tension band, remains securely closed.

### BRIEF SUMMARY OF THE INVENTION

This is achieved in a gas bag module for a vehicle occupant restraint device comprising a gas generator for inflating a gas bag, at least one discharge opening formed in a rigid component of the gas bag module, through which discharge opening gas generated by the gas generator and directed into the gas bag can be discharged, and at least one valve flap which in a closed position closes the discharge opening and in an open position exposes the discharge opening. The valve flap is in an initial closed position in the non-activated state of the module. At least one detent device is provided fixing the valve flap, which moves from the open position into a final closed position, in the closed position. In this way, a secure and permanent closure of the valve flap is ensured, whereby the gas volume provided by the gas generator can be utilized more effectively.

Preferably, the detent device is a purely mechanical device which is able to be produced at a particularly favorable cost and is scarcely liable to break down.

According to a preferred embodiment, the detent device has an elastically deformable detent spring.

The detent spring can lock the detent device permanently in the final closed position. Thereby, a particularly simply constructed and nevertheless effective detent device is provided, which holds the valve flap securely in the final closed position.

Preferably, the detent spring is deformed before the final closed position is reached, and remains deformed in the final closed position, whereby it reliably locks the detent device.

According to a preferred embodiment, the detent device can assume two positions, a holding position in the initial closed position, in which the detent device holds the valve flap detachably, and a locking position in the final closed position. The detent device therefore fulfils two functions. It locks not only the valve flap in the final closed position, but also serves to hold the flap in its initial closed position before and during the activation of the module until the internal pressure of the gas bag has reached a certain value. Therefore, an appropriate configuration of the detent device allows to specifically set the internal pressure of the gas bag necessary for opening the valve flap.

A particularly simple and space-saving type of construction of the detent device is produced when the detent device has an elastically deformable detent spring which holds the valve flap detachably in the holding position. The detent spring for example is a separate component attached to the flap.

Advantageously, the detent device has a first projection which is arranged in a region of the discharge opening on the rigid component of the gas bag module, and a second projection which is arranged on the valve flap.

The projections are preferably constructed such that obliquely running sections of the two projections slide on each other during closing of the valve flap. The friction which occurs with this, and possible deformation of the projections, causes kinetic energy to be dissipated during closing of the valve flap, which results in less stress on the flap system.

Preferably, the detent device has an elastically deformable detent spring and the first projection has a stop against which the detent spring abuts after a completed opening and subsequent closing. Here, the detent spring is in the deformed state, in which it is prevented by the stop in a simple manner that the detent spring returns into its non-deformed initial state. Thus, with little effort, it is ensured that the valve flap remains securely and permanently closed in its final closed position.

The rigid component of the gas bag module can be produced from plastic in an injection molding process, in which as second component a flexible hinge is injection molded on, which connects the valve flap with the rigid component of the gas bag module. This means a comparatively small manufacturing expense with, at the same time, a good durability of the flap device.

### BRIEF DESCRIPTION OF THE DRAWINGS

FIG. 1 shows a perspective view of a generator carrier of a gas bag module according to the invention;

FIG. 2 shows a perspective half-section through the gas bag module which shows the initial closed position of the valve flap;

FIG. 3 shows a perspective half-section through the gas bag module which shows the valve flap in its open position; and

FIG. 4 shows an enlarged detail sectional view through the gas bag module with the valve flap in the final closed position.

### DETAILED DESCRIPTION OF THE PREFERRED EMBODIMENT

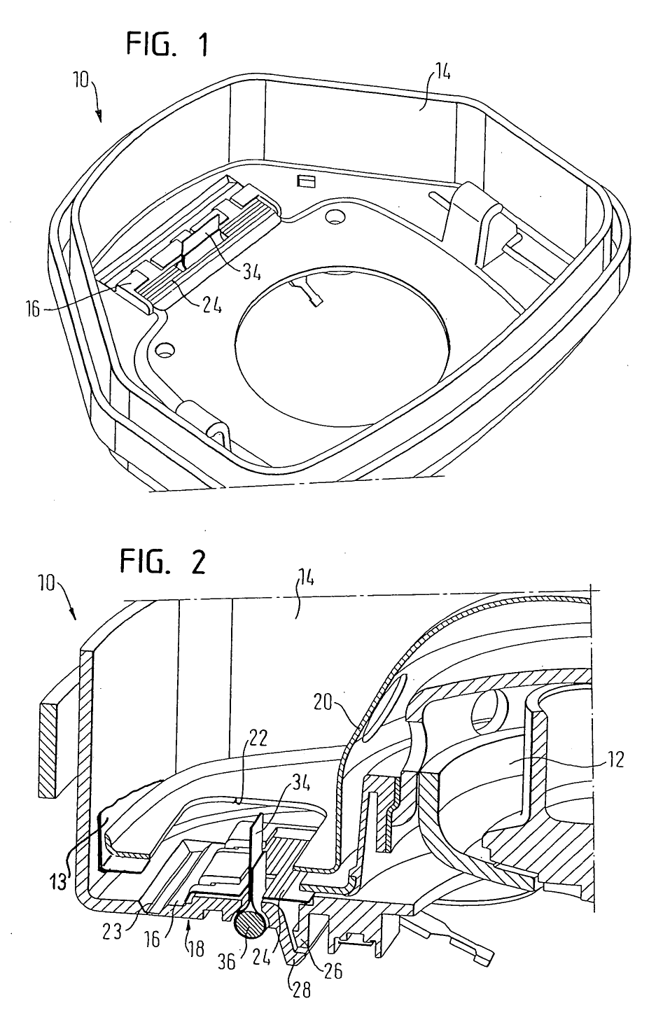

FIGS. 1 and 2 show in cut-out form a gas bag module 10 which is provided in particular for use as a driver's gas bag module, but is not restricted to this. The gas bag module 10 has a gas generator 12 and a gas bag 13. In a rigid component of the gas bag module 10 in the form of a generator carrier 14, a discharge opening 18 is provided which is able to be closed by means of a valve flap 16. Arranged around the gas generator 12 is a cage 20, which in the region of the discharge opening 18 likewise has a recess 22 in its flange. The gas bag 13 expediently is fastened to the gas bag module 10 laterally outside the valve flap 16. Here, the gas bag 13 is clamped between the cage 20 and the generator carrier 14. Alternatively, the gas bag could be provided with an outflow opening in the region of the discharge opening 18.

The discharge opening 18 and the valve flap 16 form a valve for limiting the gas bag internal pressure. Here, the valve flap 16 can be integrally connected to the generator carrier 14 via a hinge 23. In the case of a generator carrier made of plastic, a further possibility consists in injection molding the hinge 23 on as a flexible second component in a two-component injection molding process.

In addition, a detent device is provided, which has an elastically deformable detent spring 24 arranged on the valve flap 16. The detent spring 24 is securely connected with the valve flap 16. The detent device further comprises a first projection 26, which is arranged in the region of the discharge opening 28 on the generator carrier 14, and also a second projection 28, hook-shaped in cross-section, which is arranged on the valve flap 16. In the embodiment shown, the first projection 26 is constructed in one piece with the generator carrier 14 and the valve flap 16 likewise continues in one piece into the second projection 28. The first projection 26, likewise hook-shaped in cross-section, has a section 30 running obliquely, which in FIGS. 1 and 2 lies against a section 32, likewise running obliquely, of the second projection 28. Finally, a tension element 34 (e.g. a tension band) is provided, one end of which is connected with the fabric of the gas bag 13, and the other end of which is connected with the valve flap 16 via a locking bolt 36.

FIGS. 1 and 2 show the gas bag module 10 in the non-activated state. In this state, the valve flap 16 is in an initial closed position and the detent device assumes a holding position in which it holds the valve flap 16 detachably. In the holding position, the detent spring 24 is in the non-deformed state shown in the figures, in which it rests on the generator carrier 14 above the first projection 26. Thereby, the detent spring 24 holds the valve flap 16 in its initial closed position.

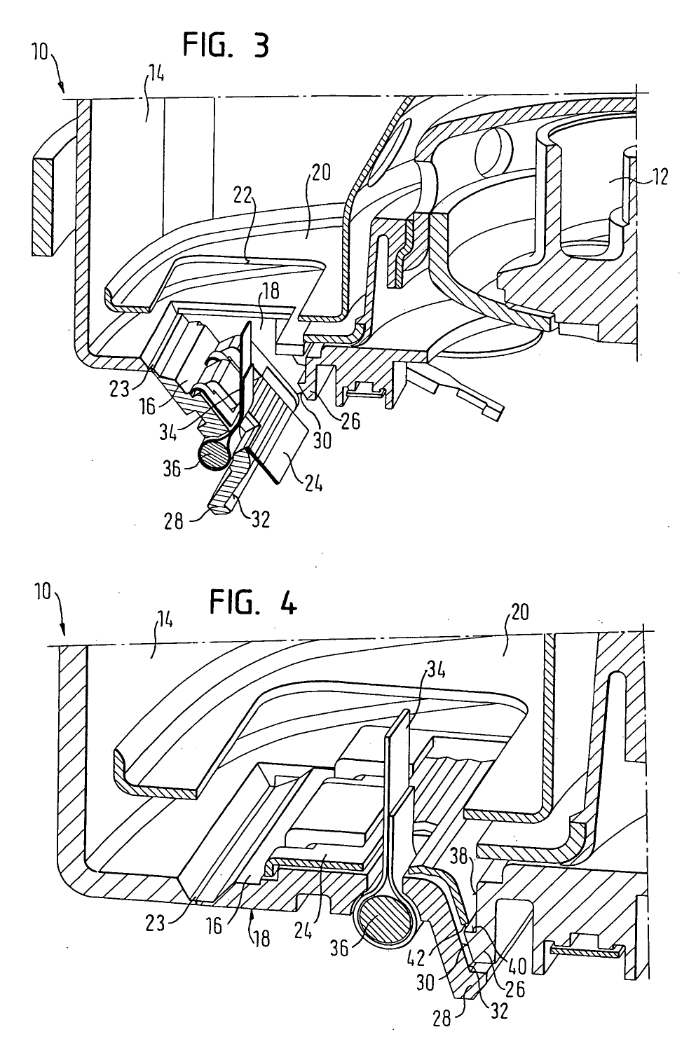

If the gas bag module 10 is now activated, then a pressure occurs in the gas bag 13, which also acts on the valve flap 16 owing to the recess 22 in the cage 20. The force resulting therefrom leads to an elastic deformation of the detent spring 24, which can be bent upwards comparatively simply perpendicularly to its longitudinal axis. Thereby, finally the valve flap 16 can reach the open position shown in FIG. 3, and the discharge opening 18 is exposed. In the open position, the detent spring 24, owing to its elasticity, returns into its non-bent initial position relative to the valve flap 16.

In the event of the gas bag 13 being able to freely unfold, the valve flap 16 is moved by the now taut tension element 34 into the final closed position, which is illustrated in FIG. 4. Here, the special design of the detent device prevents the detent spring 24 from being able to return into its original initial position (cf. FIGS. 1 and 2). With the closing movement of the valve flap 16 in fact the detent spring 24 is deformed elastically downwards by the obliquely running section 30 of the first projection 26 arranged on the generator carrier 14, and comes to lie against the obliquely running section 32 of the second projection 28 of the valve flap 16. The longitudinal dimension of the detent spring 24 and the shape of the first projection 26 are selected so that the detent spring 24 can on no account return into its initial position. The detent spring 24 therefore now assumes the position shown in FIG. 4, in which it lies against the obliquely running section 32 of the second projection 28 and also against a perpendicular stop face 38 of the first projection 26.

A further, horizontal stop face 40 is provided on the first projection 26, which comes in contact with an end face 42 of the detent spring 24, if the valve flap 16 begins to move downwards because of the internal pressure of the gas bag 13. The valve flap 16 thus receives the first projection 26 between the second projection 28 and the detent spring 24, and is locked against movement in both directions of swivelling. As the angled detent spring 24 is principally stressed as regards buckling by the force exerted by the valve flap 16, and has a high stability with respect thereto, a renewed opening of the valve flap 16 is effectively prevented.

1. A gas bag module for a vehicle occupant restraint device, comprising a gas generator (12) for inflating a gas bag (13), at least one discharge opening (18) formed in a rigid component of said gas bag module (10), through which discharge opening (18) gas generated by said gas generator (12) and directed into said gas bag (13) can be discharged, at least one valve flap (16) which in a closed position closes said discharge opening (18) and in an open position exposes said discharge opening (18), said valve flap (16) being in an initial closed position in the non-activated state of said module (10), and at least one detent device fixing said valve flap (16), which moves from said open position into a final closed position, in said final closed position.

2. The gas bag module according to claim 1, wherein said detent device is a purely mechanical device.

3. The gas bag module according to claim 1, wherein said detent device has an elastically deformable detent spring (24).

4. The gas bag module according to claim 3, wherein said detent spring (24) permanently locks said detent device in said final closed position.

5. The gas bag module according to claim 4, wherein said detent spring (24) is deformed before said final closed position is reached, and remains deformed in said final closed position.

6. The gas bag module according to claim 1, wherein said detent device can assume two positions, a holding position in said initial closed position, in which said detent device holds said valve flap (16) detachably, and a locking position in said final closed position.

7. The gas bag module according to claim 6, wherein an elastically deformable detent spring (24) holds said valve flap (16) detachably in said holding position.

8. The gas bag module according to claim 1, wherein said detent device has a first projection (26) which is arranged in a region of said discharge opening (18) on said rigid component of said gas bag module (10), and said detent device has a second projection (28), which is arranged on said valve flap (16).

9. The gas bag module according to claim 8, wherein obliquely running sections (30, 32) of said two projections (26, 28) slide on each other during closing of said valve flap (16).

10. The gas bag module according to claim 8, wherein an elastically deformable detent spring (24) is provided and said first projection (26) has a stop (38, 40) against which said detent spring (24) abuts after completed opening and subsequent closing.

11. The gas bag module according to claim 1, wherein said rigid component of said gas bag module (10) is produced from plastic in an injection molding process, in which as second component a flexible hinge (23) is injection molded on, said flexible hinge (23) connecting said valve flap (16) with said rigid component of said gas bag module (10).

12. The gas bag module according to claim 1, wherein a tension element (34) is provided, one end of which is connected with a fabric of said gas bag (13), and the other end of which is connected with said valve flap (16).
